(19) United States
(12) Patent Application Publication
(10) Pub. No.: US 2024/0190492 A1
(43) Pub. Date: Jun. 13, 2024

(54) FOLDING PUSHCART

(71) Applicant: Zenithen USA, LLC, d/b/a Z Company, Upland, CA (US)

(72) Inventors: Andrew David Frankel, Yorba Linda, CA (US); Shi-Ping Zheng, Fuzhou (CN); Tian-Xia Zheng, Fuzhou (CN)

(21) Appl. No.: 18/079,086

(22) Filed: Dec. 12, 2022

(51) Int. Cl. B62B 3/02; B62B 3/00

(52) U.S. Cl. CPC B62B 3/025; B62B 3/005; B62B 2205/06; B62B 2205/20; B62B 2205/30; B62B 2301/044

(57) ABSTRACT

A folding pushcart, comprising a foldable cart body frame and a storage bag. The two sides of the body frame are hinged by two groups of first slanting rods and second slanting rods intersecting in the middle. The first diagonal rods in the corresponding groups on both sides are bent from a rod, and the bent bottom rod section faces the front and rear ends. The bottom rod section is used to support and tighten the bottom of the storage bag. The front and rear facades and the middle of the cart body frame are hinged by three U-shaped columns, and support the upper edge of the storage bag, forming a whole structure that can be folded and unfolded.

### BACKGROUND OF THE INVENTION

### Field of the Invention

The invention is in the field of transportation equipment, and particularly relates to a type of folding pushcart, especially to a cart capable of being folded into a flat surface.

### Technical Background

There are many existing designs for folding pushcarts, and these designs can be roughly divided into two types: flat folding and full folding. In the flat folding type, the left and right sides are supported by stretchable structures, while the front and rear facades of the cart body can be folded together and unfolded. The following are examples of this type:

CN2014800420171 shows a type of foldable pushcart, which has a foldable frame that can be positioned in an open position and a folded position and is connected to multiple wheels of the foldable frame. It also has a plurality of substantially rigid seats pivotally coupled to the foldable frame and a flexible housing forming a side wall for the pushcart around the foldable frame. Each substantially rigid seat has a substantially rigid seat back and a substantially rigid seat bottom hinged to the seat back. The supports on both sides of the folding frame are composed of two hinged quadrilateral rods, which can be lifted and folded along the facade.

CN201922213235.X shows an easy-to-use, foldable pushcart, including a frame body, a caster assembly, and a handle assembly. Both the left and right sides of the frame body utilize a telescopic structure that can be retracted front and rear so that the frame body can be folded front and rear or unfolded. The front and rear telescopic structure is actually a group of two cross diagonal rods, the upper and lower ends are hinged with the front and rear facades, forming a telescopic structure from the front and rear facades to the middle facade.

The second, full folding type is two-dimensional folding, which can be folded into bundles. The four facades of the front, rear, left, and right can be folded together and can subsequently be unfolded. It is also called three-dimensional folding, which is easier to store than the former type.

CN202121411194.6 shows a foldable pushcart, which includes a foldable body frame, a storage bag, casters and a push-pull rod assembly. The cart body frame has four facades: front, rear, left, and right, and a bottom plane, wherein the front, rear, left and right sides of the four facades include a set of more than one set of diagonal rods with cross articulation, and casters are installed on the hinge bases. It is characterized by: the bottom plane of the body frame is supported by two folding rod groups distributed in left and right directions. The folding rod group includes a front rod, a rear rod, and a bridging piece. The bridging piece connects one end of the front rod and the rear rod, and the other end of the front rod and the rear rod is hinged on the hinge bases on the front and rear facades. The hinge bases are correspondingly formed with horizontal slots. When the cart body frame is opened in place, the front and rear rods are partially placed in the horizontal slot and supported; at the same time, it also forms a guiding effect on the hinge bases.

In the two-dimensional folding scheme, the four facades are all foldable structures, which are easy to twist after opening, and the rigidity is relatively weak; moreover, the weights of the intersecting diagonal rods are loaded in the storage bag, so the four corners will be slightly deformed downwardly. Determining how to improve upon the inefficiencies of the current technology is one focus of this invention.

### SUMMARY OF THE INVENTION

One purpose of the present invention is to provide a folding pushcart whose left and right facades are composed of intersecting diagonal rods, and the front and rear facades are connected by U-shaped columns, so that translation and folding are smoother.

The invention was completed in or more of the following manners:

A folding pushcart, comprising a foldable cart body frame and a storage bag sleeved on the cart body frame. The cart body frame has four facades at the front and rear ends and its left and right, and is characterized by: two sets of cross-hinged first diagonal rods and second diagonal rods in the middle, the lower ends of the adjacent groups of first diagonal rods are hinged to each other. The upper ends of the second diagonal rods are hinged to a slide bushing. The first diagonal rods of the corresponding groups on both sides of the facade are bent from a rod piece, and the bent bottom rod section faces the front and rear ends. The bottom rod section is used to support and tighten the bottom of the storage bag. It also includes three U-shaped columns that are separated at both ends and the middle, and are associated with the left and right facades. The U-shaped columns have two column sections and a U bottom section.

It also includes a U-shaped column in the middle. The U bottom section is located on the lower side of the bottom of the storage bag. The upper part of the column section correspondingly passes through the slide bushing on the same side, and the lower part is hinged with two first hinge pieces. The other ends of the two first hinge pieces are correspondingly hinged on the first diagonal rod in the two groups of diagonal rods. The upright and associated state of the U-shaped column in the middle is maintained by the slide bushing and the first hinge piece, and the edge of the middle part of the storage bag is supported by the end of the column section;

The column sections of the U-shaped column at the front and rear ends provide the associated hinges of the first diagonal rods and second diagonal rods both sides, as well as the location for installing the casters. The U-shaped column at the front end also provides the location for installing the push-pull rod.

The associated hinge means is provided as follows: The end of the second diagonal rod in the two groups of diagonal rods is correspondingly hinged to the lower part of the column section of the U-shaped column at both ends, and the middle part of the column section is hinged with a second hinge piece. The other end of the second hinge piece is correspondingly hinged to the first diagonal rod on the same side, keeping the upright and associated state of the U-shaped columns at both ends, and allowing the two groups of diagonal rods to fold and unfold.

The U bottom section of the U-shaped column at the front and rear ends has the following combined orientation: 1. The two U bottom sections are located at the bottom of the storage bag, the front and rear casters are directly installed on the two U bottom sections, and the end of the column section supports the four corners of the storage bag. 2. The bottom sections of the two U's face upwards and support the edges of the front and rear ends of the storage bag. The casters are directly set on the downward ends of the four column sections. 3. The U bottom section at the front end faces upwards and supports the front edge of the storage bag, and the two column sections face the lower end and are directly mounted on the casters. The U bottom section at the rear end faces downward, the casters are directly mounted on the U bottom section, and the ends of the two column sections support the two corners of the rear end of the storage bag.

A U-shaped door lever can be swing-hinged between the two upward column sections of the U-shaped column on the rear facade. The back end of the storage bag is sewn into a movable tongue that can be opened backwards. The movable tongue is sheathed on the U-shaped door lever and can follow the U-shaped door lever to perform opening and closing actions. When closed in place, it is locked by the strap arranged on the outside of the storage bag.

The end of the strap is provided with a matching buckle, which is locked by the buckle.

The push-pull rod is a bent U-shaped push-pull rod, and the two ends are directly hinged to the middle and upper parts of the two column sections of the U-shaped column at the front end and are kept upturned by means of a rightening belt sewn on the upper part of the front facade of the storage bag state.

The first diagonal rod in the two groups of diagonal rods is folded downwardly from the cross hinge point towards one end of the middle part, and the downward folding angle is between 10-15 degrees. The second diagonal rod is folded upwards from the cross hinge point towards the end, and the upward folding angle is between 10-15 degrees. During the opening process, the end of the first diagonal rod toward the end can cross over the second hinge piece to form an interference state and keep abutting against the second diagonal rod.

The lower ends of the first diagonal rods of the adjacent groups are each hinged by means of a plastic part, and the plastic parts are interspersed to avoid each other so that the first diagonal rods in the two groups can be in a plane. The second diagonal rods are respectively hinged on the slide bushing 3 and are in the same plane.

The two column sections of the U-shaped column in the middle are provided with hooks corresponding to the horizontal position of the bottom rod sections of the two first diagonal rods, and a tension rope is arranged between the hook and the bottom edge of the storage bag or alternatively, the two ends of the reinforced strap sewn transversely in the middle of the storage bag are fastened on the hook.

The invention has the characteristics of unique concept, ingenious structure, smooth operation, and a small volume occupied by folding. In particular, the front, rear and middle parts are connected by U-shaped columns on both sides, which ensures rigidity and provides a reliable foundation for caster positioning. During the folding and opening process, the U-shaped columns at the front and rear ends can follow the movement of the cross-hinged diagonal rods, and the front and rear casters move and roll together without resistance, and still form a support for the whole. The unfolding and folding operations are smooth and barrier-free, and the folded plane is neat and docile.

### BRIEF DESCRIPTION OF THE DRAWINGS

FIG. 1 shows a schematic rear view of the folding pushcart in an open state.

FIG. 2 shows a schematic rear view of the folding pushcart in a closed state.

FIG. 3 shows a zoomed schematic diagram of Selection A from FIG. 2.

FIG. 4 shows a schematic view of the cart body frame in an open state.

FIG. 5 shows a zoomed view of Selection B from FIG. 4.

FIG. 6 shows a side schematic view of the cart body frame in an open state.

FIG. 7 shows a schematic view of the folding pushcart in a folded state.

FIG. 8 shows a side schematic view of the cart body frame in a folded state.

FIG. 9 shows a schematic view of the cart body frame 2 in an open state.

FIG. 10 shows a side schematic view of the cart body frame 2 in an open state.

Similar reference characters denote corresponding features consistently throughout the attached drawings. Namely, in the drawings the following reference numbers refer to the following part:

| | |
|---|---|
| 100-Cart body frame | 12-Plastic part |
| 1-First diagonal rod | 2-Second diagonal rod |
| 11-Bottom rod section | 3: Slide bushing |
| 4-U-shaped column | 9-Push-pull rod |
| 41-Column section | 91-Rightening belt |
| 42-U bottom section | 200-Storage bag |
| 43-Hook | 201-Movable tongue |
| 44-Supporting T-shaped head | 202-Strap |
| 5-First hinge piece | 203-Buckle |
| 6-Second hinge piece | 204-Tension rope |
| 7-U-shaped door lever | X-Downward folding angle |
| 8-Caster | Y-Upward folding angle |

### DETAILED DESCRIPTION OF THE PREFERRED EMBODIMENT(S)

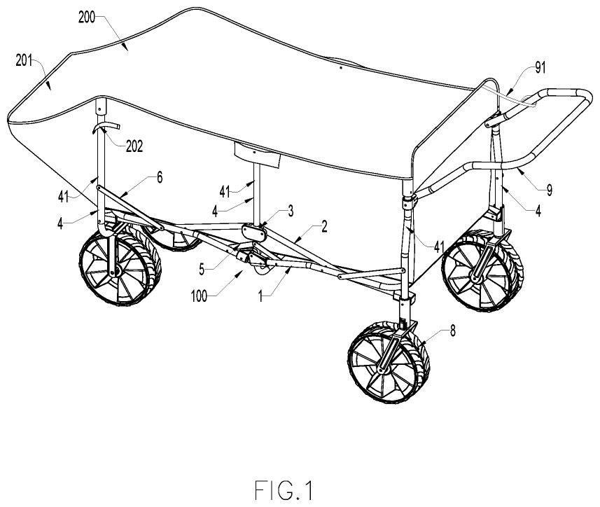

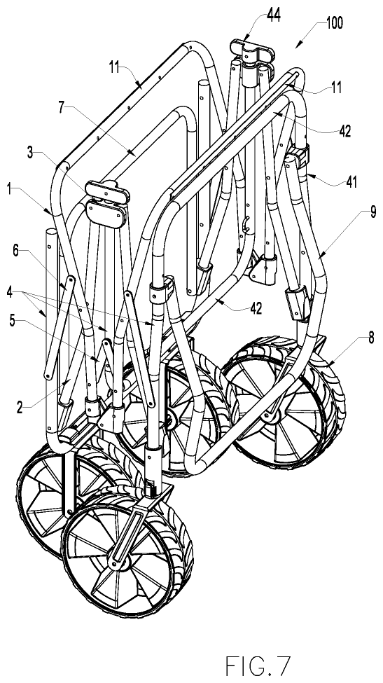

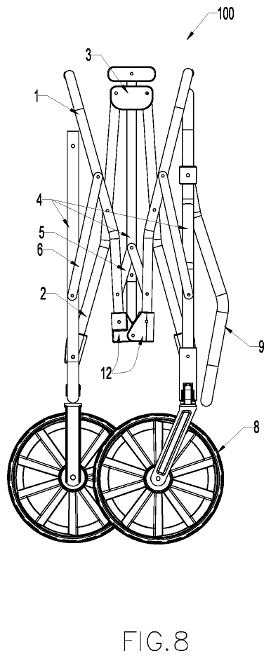

Referring now to FIGS. 1 to 8, a folding pushcart, comprising a foldable cart body 100 frame and a storage bag 200 sleeved on the cart body frame is shown. The cart body frame 100 has four facades, namely at the front and rear ends and on the left and right sides. The left and right facades include two sets of first diagonal rods 1 and second diagonal rods 2 cross-hinged in the middle. The lower ends of the first diagonal rods 1 of the adjacent groups are hinged to each other, and the upper ends of the second diagonal rods 2 are hinged to a slide bushing 3, forming a connection between the two groups of diagonal rods on the same side, and can be unfolded and folded around their respective hinge points. In the figure, the lower ends of the first diagonal rods 1 of the adjacent groups are each hinged by means of a plastic part 12, and the plastic part 12 is interspersed to avoid the two groups, so that the first diagonal rods 1 in the two groups can be in the same plane. The second diagonal rods are respectively hinged on the slide bushing 3 and are in the same plane.

Among them, the first diagonal rods 1 of the corresponding groups on both sides of the facade are bent from a rod. The bent bottom rod section 11 faces the front and rear ends, and the bottom rod section 11 is used to support and tighten the storage bottom of bag 200. Therefore, the two ends of the storage bag 200 can be tightened to form a support for placing items. At the same time, it also serves as a rigid relationship between the facades on both sides.

It may further comprise three U-shaped columns 4 that are separated at both ends and in the middle, and are connected to the left and right facades to form a connection between the two ends of the diagonal rods on both sides, so as to improve the overall rigidity of the cart body frame 100. The U-shaped column 4 has two column sections 41 and a U bottom section 42. It is most reasonable to use one rod to bend, but it does not rule out the scheme that the split rods are hinged into a U-shaped frame through plastic parts.

A U-shaped column 4 is provided in the middle. The U bottom section 42 is located on the lower side of the bottom of the storage bag 200. The upper part of the column section 41 correspondingly passes through the slide bushing 3 on the same side, and the lower part is hinged with two first hinge pieces 5. The other ends of the two first hinge pieces 5 are correspondingly hinged on the first diagonal rod 1 in the two groups of diagonal rods, the upright and associated state of the U-shaped column 4 in the middle is maintained by the slide bushing 3 and the first hinge piece 5, and the edge of the middle part of the storage bag 200 is supported by the end of the column section 41. That is to say, with the help of a U-shaped column 4 in the middle, the connection between the hinges at the ends of two groups of diagonal rods has been formed, and in turn, the column section 41 can be righted, and the column section 41 can be used to support the middle part of the storage bag 200, so as to avoid the middle part from drooping. For this reason, a supporting T-shaped head 44 is locked on the top of the column section 41 to increase the supporting area.

The column sections 41 of the U-shaped column 4 at the front and rear ends provide the associated hinges of the first diagonal rods 1 and second diagonal rods 2 on both sides. It also provides the location for installing the casters 8. The U-shaped column 4 at the front end also provides the location for installing the push-pull rod 9.

More specifically, the associated hinge means includes the end of the second diagonal rod 2 in the two groups of diagonal rods, which is correspondingly hinged to the lower part of the column section 41 of the U-shaped column at both ends, and the middle part of the column section 41 is hinged with a second hinge piece 6. The other end of the second hinge piece 6 is correspondingly hinged to the first diagonal rod 1 on the same side, so that this end of the first diagonal rod 1 can be suspended to support the end of the storage bag, while the second hinge piece 6 keeps the upright and associated state of the U-shaped columns 4 at both ends. This allows the two groups of diagonal rods to fold and unfold.

The U bottom section 42 of the U-shaped column at the front and rear ends has the following combined orientation:

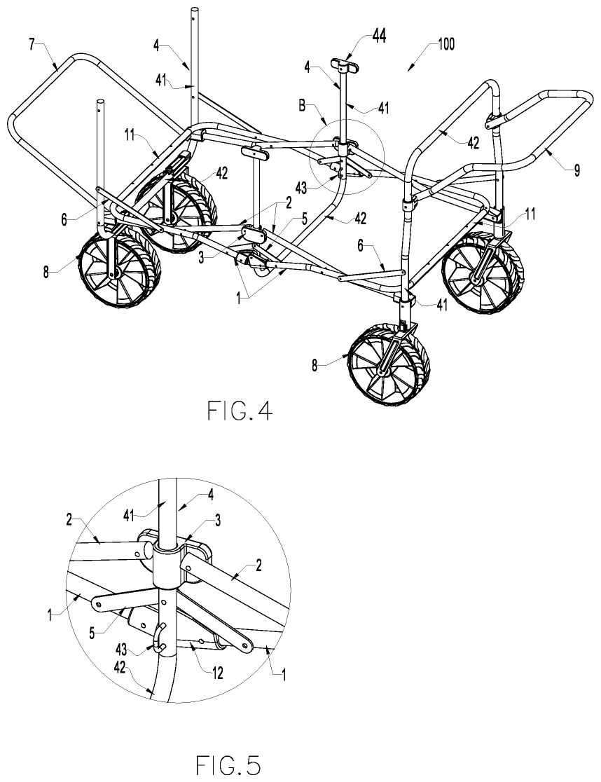

1. The two U bottom sections 42 are all facing downward, that is, they are located at the bottom of the storage bag 200. The front and rear casters 8 are directly installed on the two U bottom sections 42, and the ends of the column sections 41 support the four corners of the storage bag 200. This structure is convenient for the installation of the casters 8, which can be designed as four casters or three casters, and the distance between the casters 8 is relatively flexible. The disadvantage is that the upper edge of the storage bag forms a six-point support situation, and there is no edge to rely on. Pushing and pulling can only be done by pushing the push-pull bar 9. For its equivalent figure, please refer to the rear facade of FIG. 4. In order to tighten the relationship between the upper edge of the storage bag 200, a superimposed U-shaped bar with the bottom of the U facing upward can be riveted on the column sections 41 at the front and rear ends, or a horizontal bar can be riveted directly at the ends of the two column sections 41, thus forming a closed rigid body.

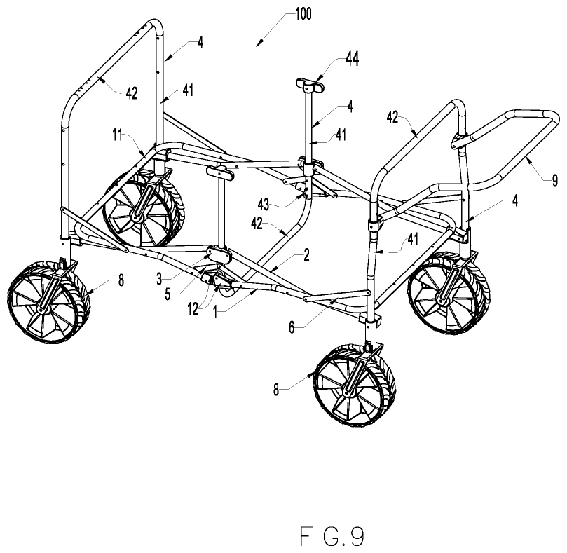

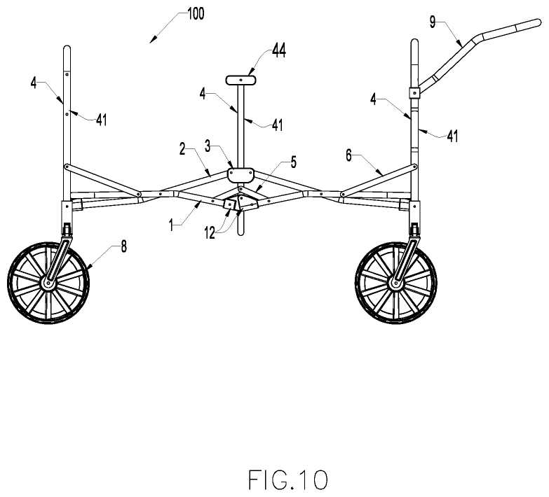

2. Referring to FIG. 9 and FIG. 10, both U bottom sections 42 face upwards, and support the edges of the front and rear ends of the storage bag 200, and the casters 8 are directly sleeved on the downward ends of the four column sections 41. The installation positions of the four casters 8 of this structure are relatively fixed, the upper edges of the two ends of the storage bag 200 are supported, and the edges are rigidly supported, and can be directly pushed or pulled by hand without using the push-pull rod 9, thus providing great convenience. The bottom rod section 11 of the first diagonal rod is associated with the bottom of the cart body frame.

3. As shown in FIGS. 1 to 8, the U bottom section 42 at the front end faces upwards and supports the front end edge of the storage bag 200. The two column sections 41 are directly mounted on the upper caster 8 toward the lower end. The U bottom section 42 at the rear end faces downwards. The casters 8 are directly mounted on the U bottom section 42. The ends of the two column sections 41 support the two corners of the rear end of the storage bag 200.

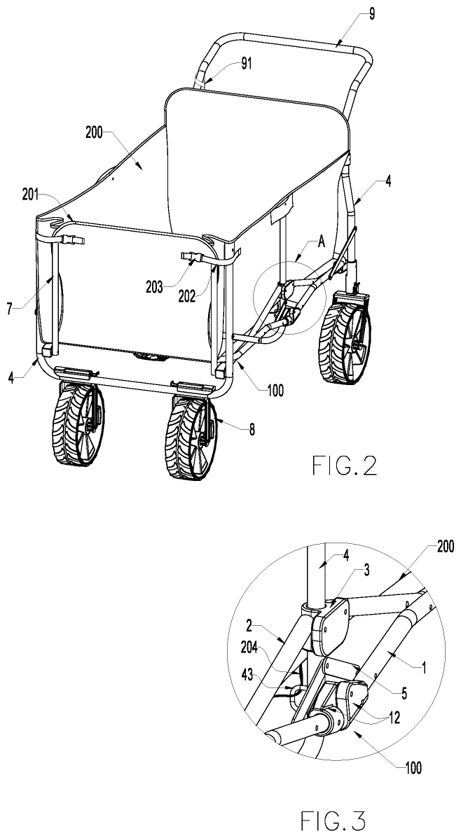

On the basis of the first and third combination schemes, a U-shaped door lever 7 can be swing-hinged between the two upward column sections 41 of the U-shaped column on the rear facade. The back end of the storage bag 200 is sewn into a movable tongue 201 that can be opened backwards. The movable tongue 201 is sheathed on the U-shaped door lever 7 and can follow the U-shaped door lever 7 to perform opening and closing actions. And when closed in place, it is locked by the strap 202 arranged on the outside of the storage bag 200. More specifically, the end of the strap 202 is provided with a matching buckle 203, which can be locked by means of the buckle 203 and can realize fast locking and unlocking operations. After untying, the U-shaped door lever 7 swings backwards to the designed inclined shape and is pulled by the side cloth of the storage bag 200. It maintains the inclined state, so that the rear end of the storage bag 200 can be opened, so as to place items longer than the cart body frame 100, as shown in FIGS. 1 and 2. The hinge point of the U-shaped door lever 7 and the column section 41 can be selected to be the same hinge point as the second diagonal 2, so as to save assembly process.

Further, the push-pull rod 9 also adopts a bent U-shaped push-pull rod, and the two ends are directly hinged to the middle and upper parts of the two column sections 41 of the U-shaped column at the front end. It keeps its upturned state by means of a rightening belt 91 sewn on the top of the front facade of the storage bag, and is in the best operating angle of pushing and pulling. The end of rightening belt 91 is set on the push-pull rod 9 through the activity of the snare, removes the snare and makes the push-pull rod 9 lose traction. The push-pull rod 9 naturally sags to the side of the U-shaped column 4 to achieve the purpose of folding. Push-pull rod 9 still also can adopt conventional scheme, as a single rod.

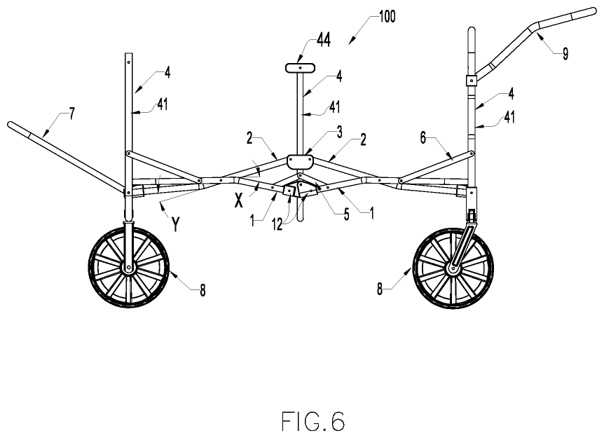

As shown in FIG. 6, in order to realize the sinking of the bottom of the storage bag 200, to form a larger accommodation space, and to get better support from the U-shaped columns 4 at the front and rear ends, the first diagonal rod 1 and the second diagonal rod 2 are properly bent. More specifically, the first diagonal rod 1 in the two groups of diagonal rods is folded downward from the cross hinge point towards one end of the middle part, and the downward folding angle is between 10-15 degrees. The second diagonal rod 2 is folded upwardly from the cross hinge point towards the end, and the upward folding angle is between 10-15 degrees. During the opening process, the end of the first diagonal rod 1 toward the end can cross over the second hinge piece 6 to form an interference state and maintain abutment against the second diagonal rod 2 to bear force. It transfers to the U-shaped column 4 by the end of the second diagonal rod 2 above, to increase the load capacity of the storage bag.

As shown in FIG. 2, the two column sections 41 of the U-shaped column in the middle are provided with hooks 43 corresponding to the horizontal position of or above the bottom rod sections 11 of the two first diagonal rods. A tension rope 204 is provided between the hook 43 and the bottom edge of the storage bag 200, or the two ends of the reinforced strap sewn transversely in the middle of the storage bag 200 are fastened on the hook. Even if the middle part of the storage bag 200 is in a tight state, effective support can be obtained and deformation can be reduced, as shown in FIGS. 2 and 3.

We claim:

1. A folding pushcart, comprising a foldable cart body frame (100) and a storage bag (200) sleeved on the cart body frame;
the cart body frame (100) has four facades and includes: two sets of cross-hinged first diagonal rods (1) and second diagonal rods (2) in the middle;
the lower ends of the adjacent groups of first diagonal rods (1) are hinged to each other, and the upper ends of the second diagonal rods (2) are hinged to a slide bushing (3);
the first diagonal rods (1) of the corresponding groups on both sides of the facade are bent from a rod piece, and the bent bottom rod section (11) faces the front and rear ends;
the bottom rod section (11) is used to support and tighten the bottom of the storage bag (200). it also includes:
three u-shaped columns (4) that are separated at both ends and the middle, and are associated with the left and right facades; the u-shaped columns (4) have two column sections (41) and a u bottom section (42);
a u-shaped column (4) in the middle; the u bottom section (42) is located on the lower side of the bottom of the storage bag (200). the upper part of the column section (41) correspondingly passes through the slide bushing (3) on the same side, and the lower part is hinged with two first hinge pieces (5);
the other ends of the two first hinge pieces (5) are correspondingly hinged on the first diagonal rod (1) in the two groups of diagonal rods, the upright and associated state of the u-shaped column (4) in the middle is maintained by the slide bushing (3) and the first hinge piece (5), and the edge of the middle part of the storage bag (200) is supported by the end of the column section (41);
the column sections of the u-shaped column (41) at the front and rear ends provide the associated hinges of the first diagonal rods (1) and second diagonal rods (2) both sides, as well as the location for installing the casters (8), and the u-shaped column (4) at the front end also provides the location for installing the push-pull rod (9).

2. A folding pushcart according to claim 1, wherein:
the end of the second diagonal rod (2) in the two groups of diagonal rods is correspondingly hinged to the lower part of the column section (41) of the U-shaped column at both ends, and the middle part of the column section (41) is hinged with a second hinge piece (6);
the other end of the second hinge piece (6) is correspondingly hinged to the first diagonal rod (1) on the same side, keeping the upright and associated state of the U-shaped columns (4) at both ends, and allowing the two groups of diagonal rods to fold and unfold.

3. A folding pushcart according to claim 2, wherein the U bottom section (42) of the U-shaped column at the front and rear ends comprises:
A. Both U bottom sections (42) are located at the bottom of the storage bag (200), the front and rear casters (8) are directly installed on the two U bottom sections (42), and the end of the column section (41) supports the storage bag (200) at the four corners;
B. The two U bottom sections (42) are all facing upwards, and support the front and rear edges of the storage bag (200), and the casters (8) are directly sleeved on the downward ends of the four column sections (41);
C. The U bottom section (42) at the front end faces upwards and supports the front end edge of the storage bag (200), and the two column sections (41) are directly mounted on the upper caster (8) toward the lower end. The U bottom section (42) at the rear end faces downwards, the casters (8) are directly mounted on the U bottom section (42), and the ends of the two column sections (41) support the two corners of the rear end of the storage bag (200).

4. A folding pushcart according to claim 3, wherein a U-shaped door lever (7) can be swing-hinged between the two upward column sections (41) of the U-shaped column on the rear façade;
the back end of the storage bag (200) is sewn into a movable tongue (201) that can be opened backwards;
the movable tongue (201) is sheathed on the U-shaped door lever (7), and can follow the U-shaped door lever (7) to perform opening and closing actions, and when closed in place, it is locked by the strap (202) arranged on the outside of the storage bag.

5. A folding pushcart according to claim 4, wherein the end of the strap (202) is provided with a matching buckle (203), and is locked by means of the buckle (203).

6. A folding pushcart according to claim 1, wherein the push-pull rod (9) is a bent U-shaped push-pull rod (9), and the two ends are directly hinged to the middle and upper parts of the two column sections (41) of the U-shaped column at the front end, and are kept upturned by means of a rightening belt (91) sewn on the upper part of the front facade of the storage bag state.

7. A folding pushcart according to claim 2, wherein the first diagonal rod (1) in the two groups of diagonal rods is folded downward from the cross hinge point towards one end of the middle part, and the downward folding angle is between 10-15 degrees; the second diagonal rod (2) is folded upwards from the cross hinge point towards the end, and the upward folding angle is between 10-15 degrees; so that during the opening process, the end of the first diagonal rod (1) toward the end can cross over the second hinge piece (6) to form an interference state, and keep abutting against the second diagonal rod (2).

8. A folding pushcart according to claim 7, wherein the lower ends of the first diagonal rods (1) of the adjacent groups are each hinged by means of a plastic part (12), and the plastic parts (12) are interspersed to avoid each other, so that the first diagonal rods (1) in the two groups can be in a plane;
the second diagonal rods (2) are respectively hinged on the slide bushing (3) and are in the same plane.

9. A folding pushcart according to claim 1, wherein the two column sections (41) of the U-shaped column in the middle are provided with hooks (43) corresponding to the horizontal position of the bottom rod sections of the two first diagonal rods (11), and a tension rope (204) is arranged between the hook (43) and the bottom edge of the storage bag (200), or the two ends of the reinforced strap sewn transversely in the middle of the storage bag (200) are fastened on the hook (43).
